(19) United States
(12) Patent Application Publication
(10) Pub. No.: US 2015/0036183 A1
(43) Pub. Date: Feb. 5, 2015

(54) PRINTING CONTROL DEVICE, CONTROL METHOD FOR PRINTING CONTROL DEVICE, AND STORAGE MEDIUM

(71) Applicant: CANON KABUSHIKI KAISHA, Tokyo (JP)

(72) Inventor: Hiroya Igarashi, Yokohama-shi (JP)

(21) Appl. No.: 14/444,552

(22) Filed: Jul. 28, 2014

(30) Foreign Application Priority Data
Jul. 30, 2013 (JP) 2013-157695

(51) Int. Cl. G06K 15/00

(52) U.S. Cl. CPC G06K 15/406
USPC 358/1.15

(57) ABSTRACT

A printing control device that communicates with an image forming apparatus receives a job, and analyzes the job to determine whether the job is printable by the image forming apparatus. When the image forming apparatus shifts to a sleep state, the printing control device controls the image forming apparatus such that to return from the sleep state according to a determination that the received job is printable by the image forming apparatus.

### BACKGROUND

1. Field

Aspects of the present invention generally relate to a printing control device, a control method for the printing control device, and a storage medium.

2. Description of the Related Art

Conventional image forming apparatuses use a power-saving control technique discussed in Japanese Patent Application Laid-Open No. 2005-258957 to suppress power consumption and reduce a decrease in printing speed. The technique discussed in Japanese Patent Application Laid-Open No. 2005-258957 causes the image forming apparatus calculates time needed for the image forming apparatus to shift from a sleep state to a standby state. Thus, the image forming apparatus can return from the sleep state at appropriate timing based on raster image processing (RIP) time described below and the calculated time necessary to shift to the standby state. Herein, the RIP processing represents conversion of image data into a raster image in a print server or a client terminal which transmits the image data to the image forming apparatus. When the RIP processing is performed up to a certain point, time necessary to complete the entire RIP processing is calculated.

The image forming apparatus discussed in Japanese Patent Application Laid-Open No. 2005-258957 can return from the sleep state in the middle of the RIP processing. However, in some cases, the job may be cancelled by subsequent RIP processing. In such cases, although the image forming apparatus can shift to the standby state, printing is not performed, causing unnecessary consumption of electric power.

### SUMMARY

Aspects of the present invention are generally directed to a configuration for enabling an image forming apparatus to start return-from-sleep processing at timing that a received job is determined to be executable after the image forming apparatus is shifted to a sleep state.

According to an aspect of the present invention, a printing control device that communicates with an image forming apparatus includes a receiving unit configured to receive a job, a job determination unit configured to analyze the job to determine whether the job is printable, a determination unit configured to determine whether the image forming apparatus is shifted to a sleep state, and a control unit configured to, if it is determined that the image forming apparatus is shifted to the sleep state, control the image forming apparatus to return from the sleep state according to the determination that the job is printable.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a printing control device.

FIG. 2 is a diagram illustrating a configuration of an image processing system.

FIG. 3 is a block diagram illustrating a configuration of an image forming apparatus in the image processing system illustrated in FIG. 2.

FIG. 4 is a flowchart illustrating a control method for the image processing system.

FIG. 5 is a flowchart illustrating a control method for the image processing system.

FIG. 6 is a flowchart illustrating a control method for the image processing system.

FIG. 7 is a flowchart illustrating a control method for the image processing system.

FIG. 8 is a diagram illustrating a structure of a saddle stitching job.

FIG. 9 is a flowchart illustrating a control method for a printing control device.

FIG. 10 is a diagram illustrating a job structure.

### DESCRIPTION OF THE EMBODIMENTS

Various exemplary embodiments will be described in detail below with reference to the drawings.

### <System Configuration>

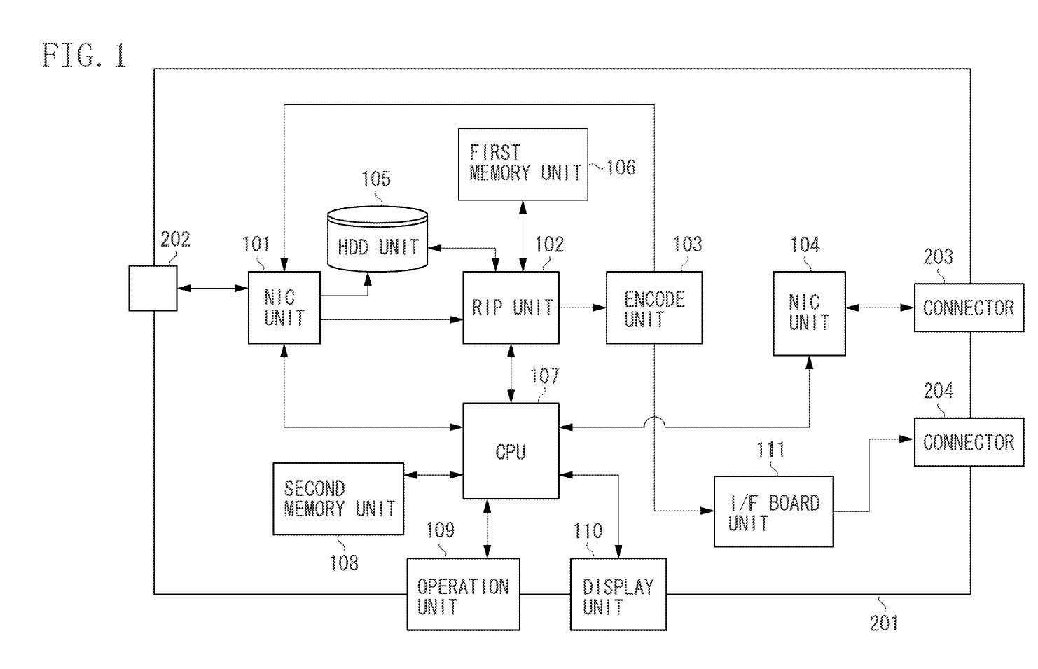

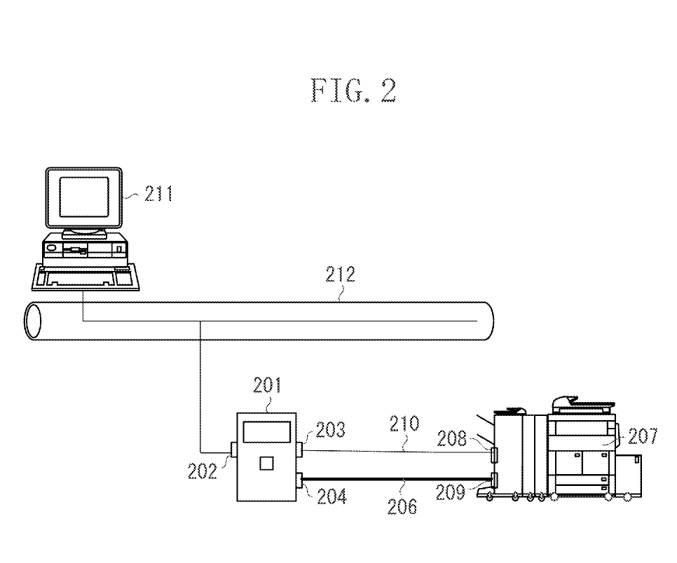

FIG. 1 is a block diagram illustrating a configuration of a printing control device 201 according to a first exemplary embodiment. The printing control device 201 of the present exemplary embodiment is locally connected to an image forming apparatus 207 in an image processing system which will be illustrated in FIG. 2. Moreover, this printing control device 201 is communicably connected to an information processing apparatus 211 on a network.

A network interface card (NIC) unit 101 illustrated in FIG. 1 is connected to a local area network (LAN) 212, which will be illustrated in FIG. 2, through a connecter 202. Herein, the NIC unit 101 functions as a first network interface. The NIC unit 101 controls a lower-layer level connection to the LAN 212 illustrated in FIG. 2. A NIC unit 104 functions as a second network interface for controlling a lower-layer level connection. The NIC unit 104 is connected to the image forming apparatus 207 through a connector 203. An interface (I/F) board unit 111 is connected to the image forming apparatus 207 through a connector 204.

A RIP unit 102 converts received data into a raster image, the received data being formed in a print language such as a page description language (PDL) or a specific data format (e.g., data compressed by joint bi-level image experts group (JBIG)). An encode unit 103 converts the raster image data into print data or a data format which is supported by the image forming apparatus 207. A hard disk drive (HDD) unit 105 temporarily stores the print data received by the NIC unit 101. The HDD unit 105 temporarily stores compressed data subsequent to the raster image processing. A first memory unit 106 is used when the RIP unit 102 performs raster image processing. A central processing unit (CPU) 107 comprehensively controls the printing control device 201. A second memory unit 108 serves as a temporary storage area. The second memory unit 108 is used when the CPU 107 temporarily stores data. An operation unit 109 includes a button, a key, and a touch panel, and is used for operation of the printing control device 201. A display unit 110 notifies an operator of information using images and characters.

The image data is transferred through a dedicated transmission path including the I/F board unit 111 and the connector 204. Hereinafter, processing of the print data received from the information processing apparatus 211 is described with reference to FIG. 1 and FIG. 2. When a data packet is transmitted from the information processing apparatus 211 to the printing control device 201, the data packet is transmitted to the LAN 212 and then accepted by the printing control device 201 through the connecter 202. Herein, the NIC unit 101 inside the printing control device 201 receives data. Upon receipt of the print data from the information processing apparatus 211, the CPU 107 controls the received data to be written into the HDD unit 105 as needed. Such processing enhances data transfer speed, and is generally called queuing (spool). The print data stored in the HDD unit 105 is read from the RIP unit 102 according to an instruction from the CPU 107. On the other hand, print data which has not been subjected to the queuing is directly transferred to the RIP unit 102 according to an instruction from the CPU 107.

Such print data transferred to the RIP unit 102 undergoes the raster image processing in the RIP unit 102. While executing the raster image processing, the RIP unit 102 determines whether the image forming apparatus 207 can print the data according to a setting. Subsequently, the encode unit 103, functioning as a second determination unit and a data format conversion unit, encodes the data into a data format interpretable by the image forming apparatus 207. Herein, the data is encoded based on a format of the received data and a data format interpretable by the image forming apparatus 207, the interpretable data format being set beforehand. Since such encoding is performed as needed, the encoding may be omitted depending on a format of the received data. For example, when the received print data is in a format interpretable by the image forming apparatus 207, the encoding is not necessary. The encoded data needs to be in a format interpretable by the image forming apparatus 207, and such an interpretable format varies depending on the capability of an interpretation unit installed in the image forming apparatus 207. The interpretable format is, for example, a specific print language format and a data format compressed by a specific method such as JBIG.

The data encoded as needed is again converted into the data packet by the NIC unit 104 so that the data is transmitted to a network cable 210. Then, the data packet is output from the connector 203 and transmitted to the image forming apparatus 207 via the network cable 210 and a connector 208. Upon receipt of the data packet, the image forming apparatus 207 performs print processing on a recording medium such as a sheet of paper according to a print processing procedure thereof. The data may be transferred by another method. For example, the data may be transferred to the I/F board unit 111 serving as an image I/F board unit through the encode unit 103, and then flows inside a dedicated transmission path 206 through the connector 204. Lastly, the data may be transmitted to the image forming apparatus 207 through a connector 209.

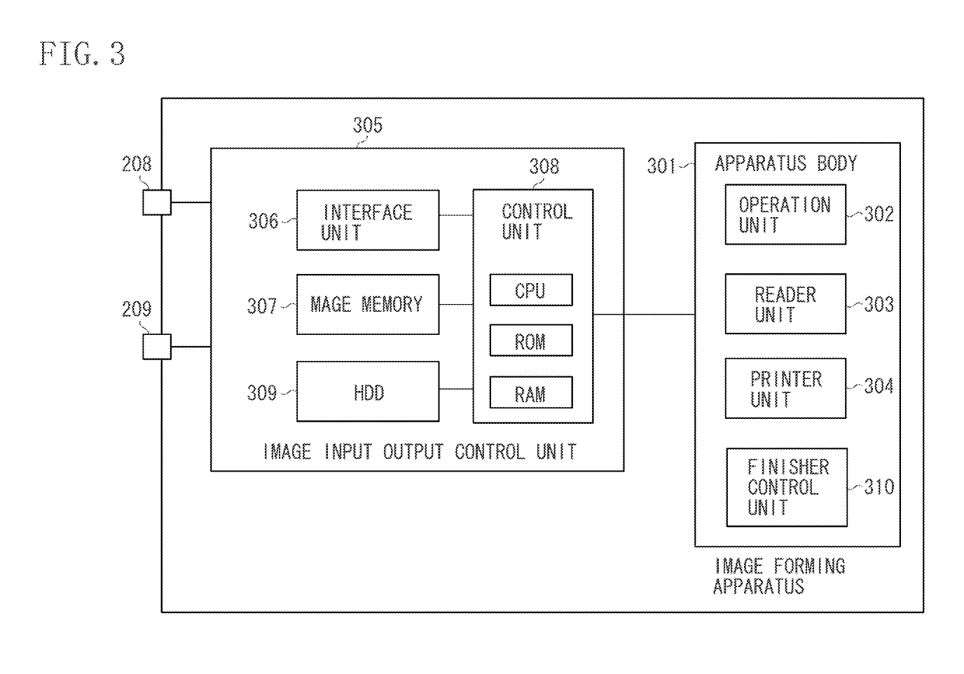

FIG. 3 is a block diagram illustrating a configuration of the image forming apparatus 207 illustrated in FIG. 2. In FIG. 3, the image forming apparatus 207 includes an apparatus body 301 and an image input output control unit 305. The apparatus body 301 includes an operation unit 302, a reader unit 303, a printer unit 304, and a finisher control unit 310. The operation unit 302 is used to operate the apparatus body 301 and the image input output control unit 305. The reader unit 303 reads an original image, and outputs image data corresponding to the original image to the printer unit 304 and the image input output control unit 305. The printer unit 304 records an image corresponding to the image data from the reader unit 303 and the image input output control unit 305 on a recording sheet. The finisher control unit 310 controls a post-processing apparatus for processing the sheet on which the image is recorded by the printer unit 304.

The image input output control unit 305 is connected to the reader unit 303. The image input output control unit 305 includes an interface unit 306, an image memory 307, a control unit 308, and an HDD 309. In the HDD 309, settings of the image forming apparatus 207 are stored (e.g., an address book, an operation history, a user setting, an identification (ID) setting, and a network setting).

The interface unit 306 interfaces the printing control device 201 and the information processing apparatus 211 on the LAN 212 with the control unit 308. The interface unit 306 causes a connector 209 to receive code data indicating an image transferred from the printing control device 201, so that the received data is converted into image data recordable by the printer unit 304. Subsequently, the interface unit 306 transfers the converted image data to the control unit 308. Moreover, the interface unit 306 receives code data representing image data transferred by the information processing apparatus 211 via the LAN 212 such as Ethernet (trademark). In addition, the interface unit 306 converts the received data into data recordable by the printer unit 304 as needed, and transfers the resultant data to the control unit 308. The connector 209 may serve as a network interface, and be connected to the printing control device 201 via a network. Moreover, the connector 209 may serve as an interface such as a parallel interface and a universal serial bus (USB) interface, and may be directly connected to the printing control device 201 via an interface cable. The connector 209 may use a plurality of cables instead of one cable. The control unit 308 includes a CPU, a read only memory (ROM), and a random access memory (RAM). The CPU of the control unit 308 loads a program stored in the ROM or another storage medium into the RAM, and executes the loaded program.

The control unit 308 controls each of data flows between the reader unit 303, the interface unit 306, and the image memory 307. The image input output control unit 305 includes the HDD 309. Alternatively, the image input output control unit 305 may include another nonvolatile memory in which data is not deleted even when power is turned off, and thus data may be stored in such a nonvolatile memory. Moreover, the control unit 308 controls the printer unit 304 and the finisher control unit 310 while determining whether printing and post-processing can be performed according to the data transmitted from the interface unit 306.

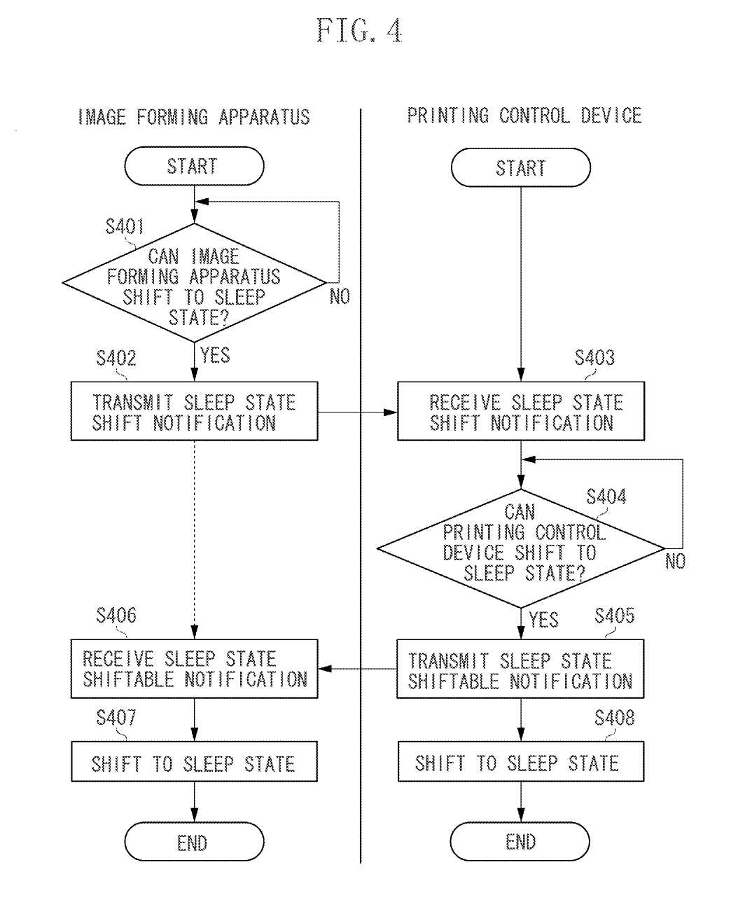

FIG. 4 is a flowchart illustrating a control method for the image processing system according to the present exemplary embodiment. The flowchart illustrated in FIG. 4 is an example processing performed when each of the image forming apparatus 207 and the printing control device 201 of the image processing system shifts to a sleep state. The left side of the flowchart illustrated in FIG. 4 represents a processing flow executed by the image forming apparatus 207, whereas the right side represents a processing flow executed by the printing control device 201. Hereinafter, an example of sleep control for each of the image forming apparatus 207 and the printing control device 201 is described. The CPU of the control unit 308 executes the sleep control corresponding to each step performed by the image forming apparatus 207. The CPU 107 executes the sleep control corresponding to each step performed by the printing control device 201.

In step S401, the CPU of the control unit 308 determines whether the image forming apparatus 207 can shift to the sleep state. An example condition for a shift of the image forming apparatus 207 to the sleep state is that the image forming apparatus 207 does not receive a job for a certain time period. If the CPU of the control unit 308 determines that the image forming apparatus 207 can shift to the sleep state (YES in step S401), the operation proceeds to step S402. In step S402, the CPU of the control unit 308 transmits a sleep state shift notification to the printing control device 201 via the connector 208 serving as a network interface, the network cable 210, and the connector 203. Then, the CPU of the control unit 308 waits for a notification that the printing control device 201 is shiftable to a sleep state, from the printing control device 201, as in step S406.

On the other hand, in step S403, the CPU 107 of the printing control device 201 receives the sleep state shift notification transmitted in step S402 from the image forming apparatus 207. Herein, the CPU 107 receives the sleep state shift notification through the connectors 203 and the NIC unit 104. The CPU 107 stores the shift of the image forming apparatus 207 to the sleep state in the second memory unit 108. In step S404, the CPU 107 determines whether the printing control device 201 can shift to a sleep state based on a determination condition. The shift to the sleep state is determined, for example, on condition that the printing control device 201 is not being accessed from an external unit such as the information processing apparatus 211. If the CPU 107 determines that the printing control device 201 can shift to the sleep state, the operation proceeds to step S405. In step S405, the CPU 107 transmits a notification that the device 201 is shiftable to a sleep state, to the image forming apparatus 207 via the connector 203, the network cable 210, and the connector 208 serving as a network interface. Subsequently, in step S408, the printing control device 201 shifts to the sleep state. Meanwhile, in step S406, the CPU of the control unit 308 receives, via the connector 208, the sleep state shiftable notification transmitted in step S405 from the printing control device 201. In step S407, the image forming apparatus 207 shifts to the sleep state.

In the present exemplary embodiment, the image forming apparatus 207 returns from the sleep state when a return condition is satisfied. For example, the return condition of the image forming apparatus 207 is satisfied when the operation unit 302 is operated, or when the print data is transmitted from the printing control device 201 to the image forming apparatus 207. Moreover, the printing control device 201 returns from the sleep state when a return condition is satisfied, for example, when an external unit accesses the printing control device 201. The access to the printing control device 201 from the external unit includes a case where the printing control device 201 receives a return-from-sleep notification from the image forming apparatus 207, and a case where the printing control device 201 receives the print data from the information processing apparatus 211.

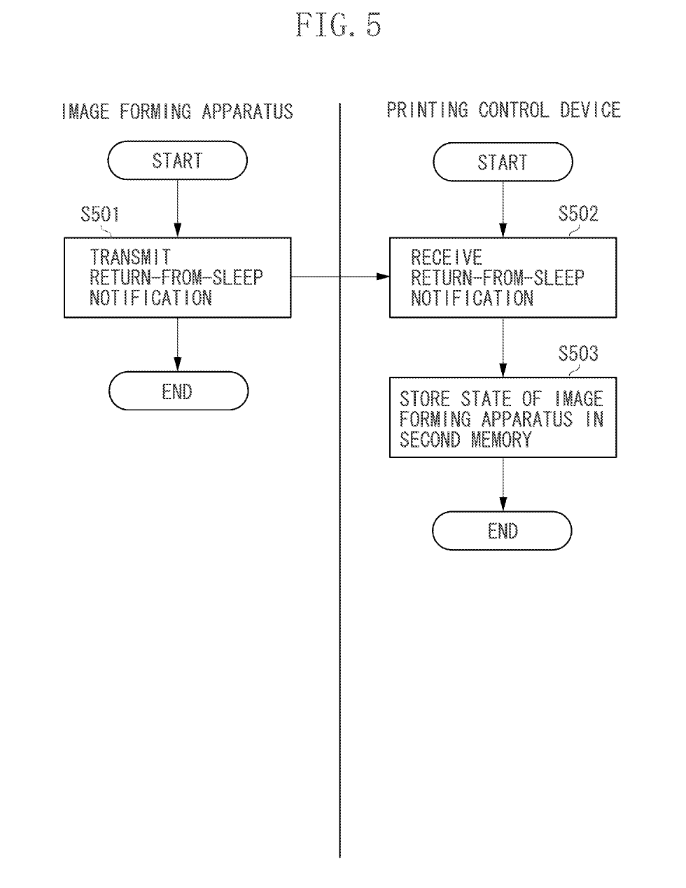

FIG. 5 is a flowchart illustrating a control method for the image processing system according to the present exemplary embodiment. The flowchart illustrated in FIG. 5 is an example processing performed when each of the image forming apparatus 207 and the printing control device 201 of the image processing system returns from the sleep state. The left side of the flowchart illustrated in FIG. 5 represents a processing flow executed by the image forming apparatus 207, whereas the right side represents a processing flow executed by the printing control device 201. Hereinafter, an example of sleep control for each of the image forming apparatus 207 and the printing control device 201 is described. The CPU of the control unit 308 executes the sleep control corresponding to each step performed by the image forming apparatus 207. The CPU 107 executes the sleep control corresponding to each step performed by the printing control device 201. A case is described with reference to FIG. 5, in which the image forming apparatus 207 returns from the sleep state.

In step S501, when the image forming apparatus 207 returns from the sleep state, the CPU of the image forming apparatus 207 transmits a return-from-sleep notification to the printing control device 201. The return-from-sleep notification is transmitted as similar to the sleep state shift notification transmitted in step S402 of the flowchart illustrated in FIG. 4. In step S502, the printing control device 201 receives the return-from-sleep notification. The return-from-sleep notification is received similar to the sleep state shift notification received in step S403 of the flowchart illustrated in FIG. 4. In step S503, the CPU 107 stores a state of the image forming apparatus 207 in the second memory unit 108. Herein, the state indicates that the image forming apparatus 207 has returned from the sleep state. In the second memory unit 108 of the printing control device 201, therefore, a state of the image forming apparatus 207 is stored, the state indicating whether the image forming apparatus 207 is in the sleep state.

### (First Return-from-Sleep Control)

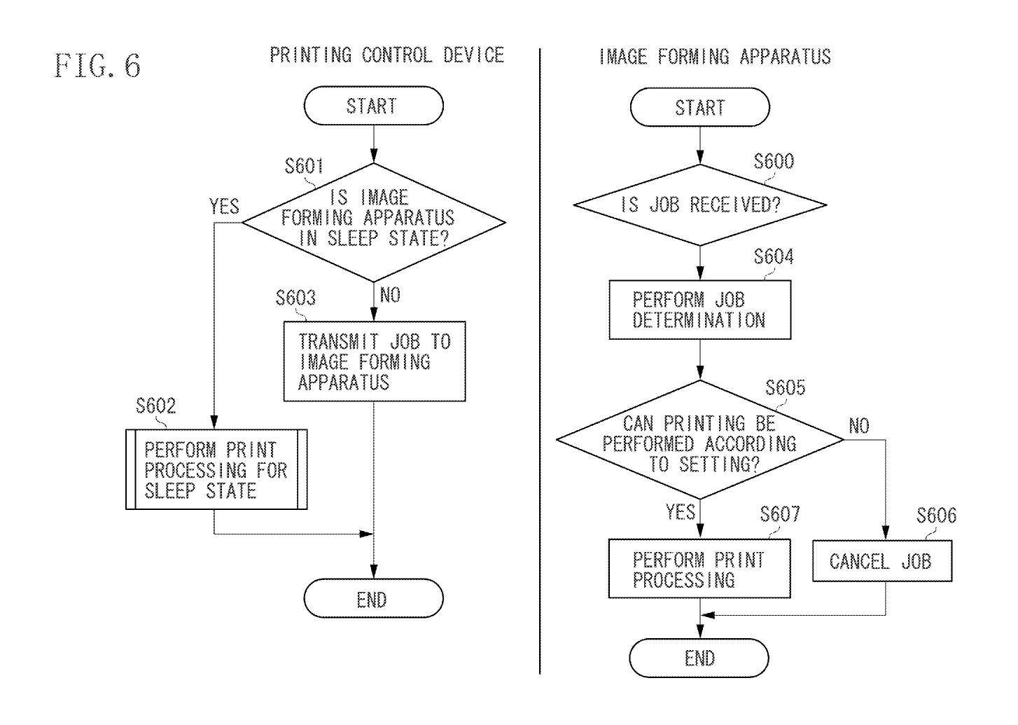

FIG. 6 is a flowchart illustrating a control method for the image processing system according to the present exemplary embodiment. The flowchart illustrated in FIG. 6 is an example of job processing performed by each of the image forming apparatus 207 and the printing control device 201 of the image processing system. The left side of the flowchart illustrated in FIG. 6 represents a processing flow executed by the printing control device 201, whereas the right side represents a processing flow executed by the image forming apparatus 207. Hereinafter, an example of sleep control for each of the image forming apparatus 207 and the printing control device 201 is described. The CPU of the control unit 308 executes the sleep control corresponding to each step performed by the image forming apparatus 207. The CPU 107 executes the sleep control corresponding to each step performed by the printing control device 201.

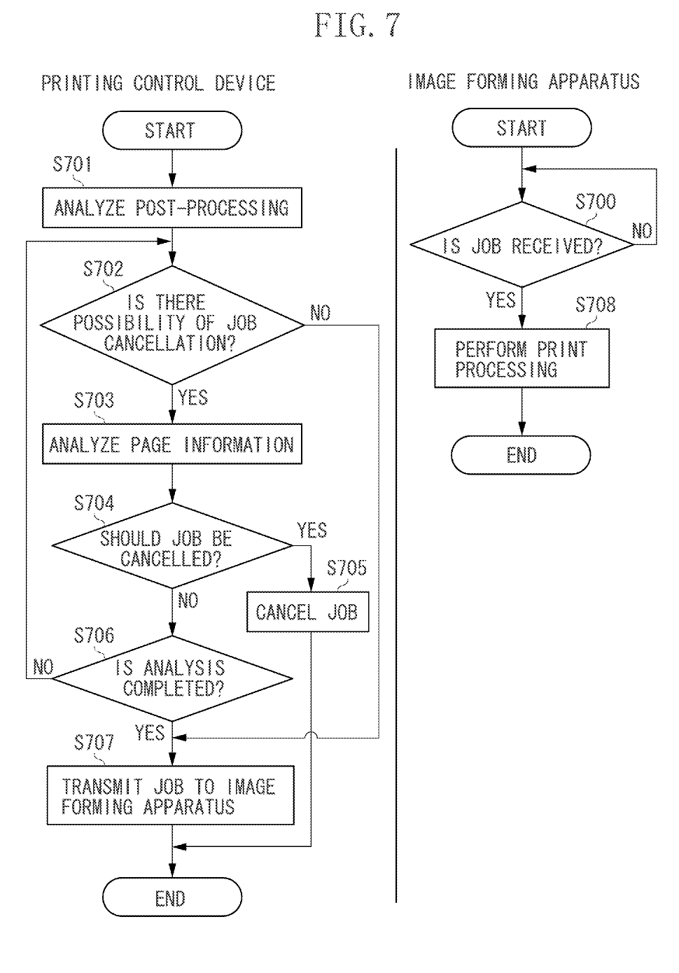

The processing in the flowchart illustrated in FIG. 6 starts when the printing control device 201 receives a print job from an external unit such as the information processing apparatus 211. In step S601, the CPU 107 of the printing control device 201 determines whether the image forming apparatus 207 is in the sleep state. As described above, the state of the image forming apparatus 207 is stored as the sleep state in the second memory unit 108 of the printing control device 201. Accordingly, the CPU 107 reads the state of the image forming apparatus 207 from the second memory unit 108 to determine whether the image forming apparatus 207 is in the sleep state. If the CPU 107 determines that the image forming apparatus 207 is in the sleep state (YES in step S601), the operation proceeds to step S602. If the CPU 107 determines that the image forming apparatus 207 is not in the sleep state (NO in step S601), the operation proceeds to step S603. The print processing in a case of the sleep state in step S602 is described below with reference to FIG. 7.

In step S603, the printing control device 201 transmits a print job to the image forming apparatus 207 through the RIP unit 102, the encode unit 103, the image I/F board unit 111, and the connector 204. Alternatively, the printing control device 201 may transmit a print job to the image forming apparatus 207 through the RIP unit 102, the CPU 107, the NIC unit 104, and the connector 203. In step S600, the image forming apparatus 207 waits for the print job from the printing control device 201. If the image forming apparatus 207 receives the print job from the printing control device 201 (YES in step S600), then in step S604, the CPU of the control unit 308 in the image forming apparatus 207 performs a job determination. Herein, the CPU of the control unit 308 determines whether the received print data can be correctly printed based on settings such as the number of pages to be printed and post processing.

For example, in a case where saddle stitching is set as post-processing, the CPU of the control unit 308 determines whether the number of pages to be printed is within a saddle staple capable range. Print data may need to be only printed, that is, post-processing may not be necessary. In such a case, the operation can immediately proceed to step S605 without waiting for a determination of how many pages can be printed. In other words, the operation proceeds to step S605 when the determination can be made instead of making a determination based on the entire print data. In step S605, the CPU of the control unit 308 determines whether the printing can be performed according to the setting of step S604. If the CPU of the control unit 308 determines that the printing cannot be performed according to the setting (NO in step S605), the operation proceeds to step S606. If the CPU of the control unit 308 determines that the printing can be performed according to the setting (YES in step S605), the operation proceeds to step S607. In step S606, the CPU of the control unit 308 cancels the print job. In step S607, the CPU of the control unit 308 issues a print instruction to each of the printer unit 304 and the finisher control unit 310 to perform the print processing.

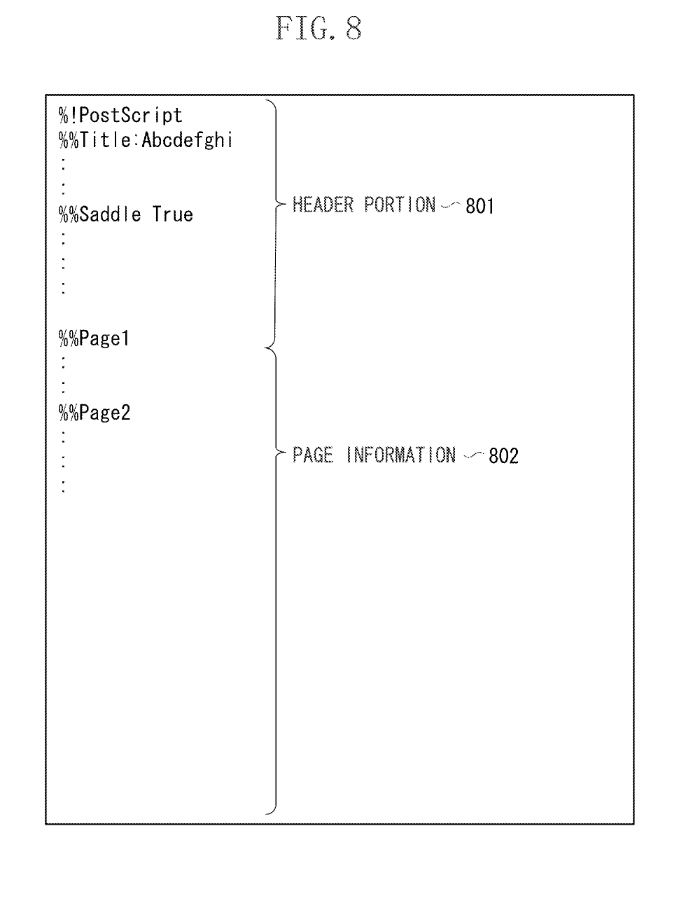

FIG. 7 is a flowchart illustrating a control method for the image processing system according to the present exemplary embodiment. The flowchart illustrated in FIG. 7 is an example of job processing performed by each of the image forming apparatus 207 and the printing control device 201 of the image processing system. The left side of the flowchart illustrated in FIG. 7 represents a processing flow executed by the printing control device 201, whereas the right side represents a processing flow executed by the image forming apparatus 207. Hereinafter, an example of sleep control for each of the image forming apparatus 207 and the printing control device 201 is described. The CPU of the control unit 308 executes the sleep control corresponding to each step performed by the image forming apparatus 207. The CPU 107 mainly executes the sleep control corresponding to each step performed by the printing control device 201. A series of operations in steps S701 through S707 of the flowchart illustrated in FIG. 7 is a detailed example of step S602 performed by the printing control device 201 in the flowchart illustrated in FIG. 6. In step S701, the RIP unit 102 analyzes the post-processing. For example, in job data of PostScript (trademark of Adobe Systems Incorporated of United States) as illustrated in FIG. 8, the RIP unit 102 searches for post-processing information in a header portion 801 from the information processing apparatus 211. In the job example illustrated in FIG. 8, description of “Saddle True” indicates that a saddle stitching job is set as the post-processing. The RIP unit 102 notifies the CPU 107 of the post-processing information. In step S702, the CPU 107 determines, based on a result of the analysis performed in step S701, whether the job can be cancelled. If the CPU 107 determines that the job can be cancelled (YES in step S702), the operation proceeds to step S703. For example, in a case of the saddle stitching job, the CPU 107 needs to determine whether the number of pages is within a limit. In such a case, in step S703, page information 802 illustrated in FIG. 8 may be analyzed.

If the CPU 107 determines that there is no possibility of cancellation (NO in step S702), for example, there is no setting of post-processing, the operation proceeds to step S707. In step S703, the RIP unit 102 analyzes the page information 802. Upon completion of the analysis of one page, the RIP unit 102 notifies the CPU 107 of the page information. Subsequently, in step S704, the CPU 107 determines whether the job should be cancelled based on the page information received in steps S701 and S703. If the CPU 107 determines that the job should be cancelled (YES in step S704), the operation proceeds to step S705. For example, if the number of pages exceeds the limit of the saddle stitching job, the operation proceeds to step S705.

On the other hand, if the CPU 107 determines that the job should not be cancelled (NO in step S704), the operation proceeds to step S706. In step S706, the RIP unit 102 determines whether the analysis of the print data is completed. If the RIP unit 102 determines that the analysis is not completed (NO in step S706), the operation returns to step S702. If the RIP unit 102 determines that the analysis is completed (YES in step S706), the operation returns to step S707. In step S707, the CPU 107 transmits the print data from the printing control device 201 to the image forming apparatus 207 similar to step S603 described above with reference to the flowchart illustrated in FIG. 6. In step S700, the image forming apparatus 207 waits for the job from the printing control device 201. In step S708, the image forming apparatus 207 generates print data from the job received in step S707, and performs print processing. Since the operation in step S708 is similar to that in step S607 of the flowchart in FIG. 6, a detailed description thereof is omitted.

According to the present exemplary embodiment, therefore, when the image forming apparatus 207 is in a power saving state, that is a sleep state, the printing control device 201 performs a job determination. Thus, the printing control device 201 controls transmission of a job to the image forming apparatus 207 based on the job determination. Under such control, a job to be cancelled is not transmitted to the image forming apparatus 207. Accordingly, the job transmission control enables the image forming apparatus 207 to remain in the sleep state. Moreover, when the image forming apparatus 207 is not in the sleep state, a job determination is performed by the image forming apparatus 207. This enables the printing control device 201 to transmit a job to the image forming apparatus 207 from a page having undergone the raster image processing without waiting for completion of the raster image processing by the printing control device 201. Thus, print start timing can be advanced. According to the present exemplary embodiment, when a job is not printed due to job cancellation, the image forming apparatus 207 does not return from the sleep state, thereby suppressing unnecessary consumption of electric power. According to the present exemplary embodiment, moreover, time necessary to complete the printing can be reduced compared to a case where a job is transmitted to an image forming apparatus after completion of raster image processing.

The first exemplary embodiment can be applied to the post-processing performed for an entire job. However, in a case where a plurality of post-processing is designated within one job such as sub-set finishing, the first exemplary embodiment cannot be applied. Hereinafter, a description is given of an example of job processing performed when a plurality of post-processing is designated within one job according to a second exemplary embodiment. In the second exemplary embodiment, processing is similar to that in the first exemplary embodiment except for step S602 described above with the flowchart illustrated in FIG. 6.

### (Second Return-from-Sleep Control)

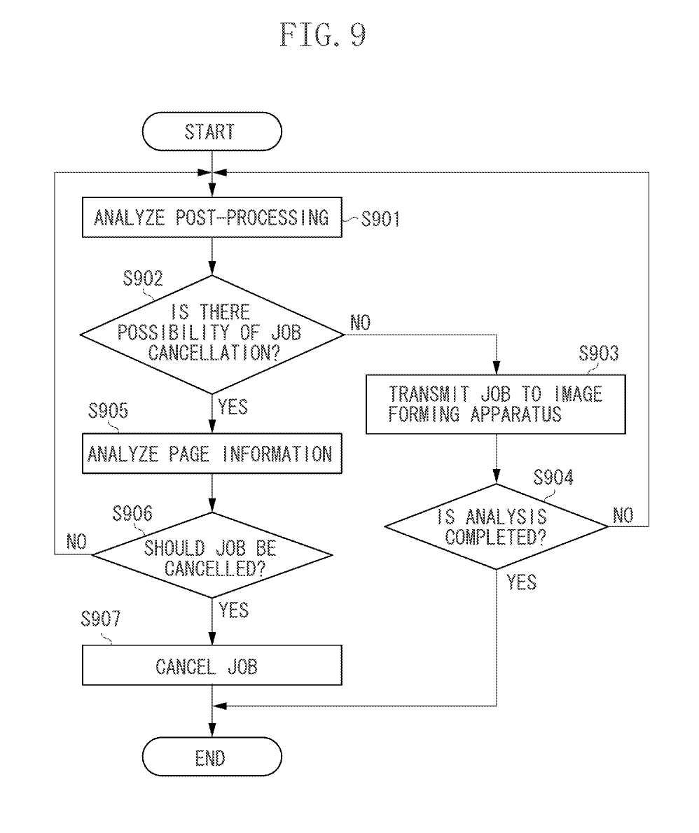

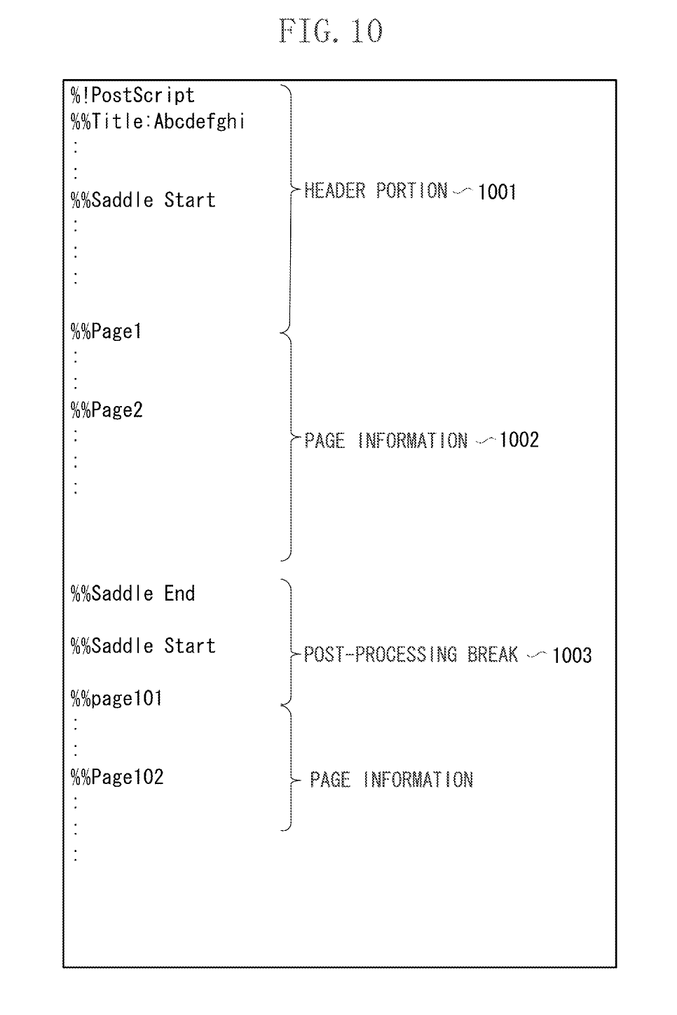

FIG. 9 is a flowchart illustrating a control method of a printing control device 201 according to the second exemplary embodiment. The flowchart illustrated in FIG. 9 is a detailed example of step S602 performed by the printing control device 201 in the flowchart illustrated in FIG. 6. A CPU 107 executes a program to perform each step illustrated in FIG. 9 for the printing control device 201. Hereinafter, a description is given of processing in which a post-processing setting of a job is analyzed with respect to each post-processing to determine whether the job is printable by an image forming apparatus 207. In step S901, a RIP unit 102 analyzes post-processing information. Particularly, the RIP unit 102 analyzes a header portion 1001 and a post-processing break 1003 illustrated in FIG. 10. The post-processing information is analyzed in order of print data. In step S901, the RIP unit 102 first analyzes the header portion 1001 only, and notifies the CPU 107 of a result of the analysis. In step S902, the CPU 107 determines whether the job can be cancelled. If the CPU 107 determines that the job can be cancelled (YES in step S902), the operation proceeds to step S905.

On the other hand, if the CPU 107 determines that the job is not cancelled (NO in step S902), the operation proceeds to step S903. In step S903, the RIP unit 102 transmits print data (job) analyzed up to this time to the image forming apparatus 207. The transmission of the print data in step S903 is similar to that in step S707 of the flowchart illustrated in FIG. 7 described above. In step S904, the RIP unit 102 determines whether the print data analysis is completed. If the RIP unit 102 determines that there is more print data which needs to be analyzed (NO in step S904), the operation returns to step S901. If the RIP unit 102 determines that the print data analysis is completed (YES in step S904), the processing of the flowchart illustrated in FIG. 9 ends. On the other hand, in step S905, the RIP unit 102 analyzes one page of the print data, and notifies the CPU 107 of a result of the analysis. In step S906, the CPU 107 determines whether the job should be cancelled. If the CPU 107 determines that the job should be cancelled (YES in step S906), the operation proceeds to step S907. On the other hand, if the CPU 107 determines that the job should not be cancelled (NO in step S906), the operation returns to step S901 in which the raster image processing continues.

In the raster image processing according to the second exemplary embodiment, therefore, the CPU 107 determines a possibility of job cancellation on a post-processing unit basis, and the RIP unit 102 transmits the job to the image forming apparatus 207. Such processing prevents cancellation of the entire job even if one of the post-processing cannot be performed. Consequently, the job can be output on the post-processing unit basis.

### Other Embodiments

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-157695 filed Jul. 30, 2013, which is hereby incorporated by reference herein in its entirety.

What is claimed is:

1. A printing control device communicating with an image forming apparatus, the printing control device comprising:
a receiving unit configured to receive a job;
a job determination unit configured to analyze the job to determine whether the job is printable by the image forming apparatus;
a determination unit configured to determine whether the image forming apparatus is shifted to a sleep state; and
a control unit configured to, if it is determined that the image forming apparatus is shifted to the sleep state, control the image forming apparatus to return from the sleep state according to the determination that the job is printable.

2. The printing control device according to claim 1, wherein the job determination unit analyzes a post-processing setting of the job to determine whether the job is printable by the image forming apparatus.

3. The printing control device according to claim 1, wherein the job determination unit analyzes a post-processing setting of the job with respect to each post-processing to determine whether the job is printable by the image forming apparatus.

4. The printing control device according to claim 1, wherein the receiving unit receives the job from an information processing apparatus.

5. The printing control device according to claim 1, further comprising an acquisition unit configured to acquire a notification of a shift to a sleep state from the image forming apparatus.

6. A printing control device communicating with an image forming apparatus, the printing control device comprising:
a receiving unit configured to receive a job;
a job determination unit configured to analyze the job to determine whether the job is printable by the image forming apparatus;
a determination unit configured to determine whether the image forming apparatus is shifted to a sleep state; and
a control unit configured to, if it is determined that the image forming apparatus is shifted to the sleep state, transfer the job received by the receiving unit to the image forming apparatus according to the determination that the job is printable.

7. A control method for a printing control device communicating with an image forming apparatus, the control method comprising:
receiving a job;
performing job determination by analyzing the job to determine whether the job is printable by the image forming apparatus;
determining whether the image forming apparatus is shifted to a sleep state; and
controlling, if the image forming apparatus is shifted to the sleep state, the image forming apparatus to return from the sleep state according to the determination that the job is printable.

8. A control method for a printing control device communicating with an image forming apparatus, the control method comprising:
receiving a job;
performing job determination by analyzing the job to determine whether the job is printable by the image forming apparatus;
determining whether the image forming apparatus is shifted to a sleep state; and
controlling, if the image forming apparatus is shifted to the sleep state, transferring the received job to the image forming apparatus according to the determination that the job is printable.

9. A computer readable storage medium storing computer executable instructions that cause a computer to execute a method, the method comprising:
receiving a job;
performing job determination by analyzing the job to determine whether the job is printable by an image forming apparatus;
determining whether the image forming apparatus is shifted to a sleep state; and
controlling, if the image forming apparatus is shifted to the sleep state, the image forming apparatus to return from the sleep state according to the determination that the job is printable.

10. A computer readable storage medium storing computer executable instructions that cause a computer to execute a method, the method comprising:
receiving a job;
performing job determination by analyzing the job to determine whether the job is printable by an image forming apparatus;
determining whether the image forming apparatus is shifted to a sleep state; and
controlling, if the image forming apparatus is shifted to the sleep state, transferring the received job to the image forming apparatus according to the determination that the job is printable.
